(19) United States
(12) Patent Application Publication
(10) Pub. No.: US 2011/0261564 A1
(43) Pub. Date: Oct. 27, 2011

(54) LIGHTING DEVICE PROVIDED WITH LEDS FOR A TUNNEL

(75) Inventors: Richard Grootveld, IJsslstein (NL); Kornelis Arie Kieviets, Rhoon (NL)

(73) Assignee: INDUSTRIAS DERIVADAS DEL ALUMINIO, S.L., Valladolid (ES)

(21) Appl. No.: 13/128,861

(22) PCT Filed: Nov. 12, 2009
(86) PCT No.: PCT/NL2009/050681

§ 371 Date: Jun. 21, 2011

(30) Foreign Application Priority Data
Nov. 12, 2008 (NL) 2002205
Jan. 9, 2009 (NL) 2002408

(51) Int. Cl. F21V 11/00; F21S 4/00

(52) U.S. Cl. 362/235; 362/249.01; 362/249.02; 362/249.07

(57) ABSTRACT

A lighting device for lighting a tunnel tube with a traffic direction, comprising a number of approximately point-like light sources, which are fixed against a tunnel tube wall, distributed along a line extending in the longitudinal direction of the tunnel and each adapted to generate a light beam, the main direction of which comprises at least one component extending in the traffic direction of the tunnel, wherein the distance between the light sources in the longitudinal direction of the tunnel is less than 5 m. The contrast for drivers of vehicles traveling in the tunnel is hereby increased relative to the contrast of usual lighting devices for the interior of the tunnel The distance between the light sources is preferably less than 0.2 m and the light sources are each provided with a LED.

### FIELD OF THE INVENTION

This invention relates to a lighting device for lighting a tunnel tube with a traffic direction, comprising a number of individual approximately point-like light sources which are fixed against a tunnel tube wall, distributed along a line extending in the longitudinal direction of the tunnel tube and each adapted to generate a light beam, the main direction of which comprises a component extending opposite to the traffic direction of the tunnel tube. The tunnel wall tube is also understood to include the tunnel wall ceiling.

### TECHNICAL BACKGROUND

Such tunnel lighting devices are known, usually with symmetrical radiation. They comprising light sources placed at a mutual distance of about 10 to 15 metres.

Such prior art lighting devices do however have the drawback that the array of light sources is discontinuous, which results in a highly location-dependent variation in the lighting level in the tunnel. Drivers perceive this as unpleasant variation of the discerned lighting level in time, also referred to as flickering.

The invention has for its object to provide a lighting device in which this drawback is obviated.

### SUMMARY OF THE INVENTION

This object is achieved with such a lighting device, wherein the distance between the light sources in the longitudinal direction of the tunnel is less than 5 m. The row of light points is hereby seen as a continuous band of light, this being perceived as much less irritating.

It is noted here that the lighting levels in the interior of tunnels are low relative to the entrance lighting, the level of which is usually related to that of the light level prevailing outside, so that it is usually possible to suffice with low-power light sources. In view of the price of electrical energy, it is important that high-efficiency light sources are applied. Use is commonly made of gas-discharge lamps, which are restricted to minimum powers, and thereby to a minimum light output, in achieving a desired efficiency. The distance between the light sources is determined by this minimum light output per light source together with the desired increase would therefore result in a reduced efficiency or an increase in the lighting level, neither of which is desirable from the viewpoint of energy consumption. Contrary to this consideration, the present invention proposes to reduce this distance.

It is noted here that it is known from the prior art to apply light sources which are placed closer together, i.e., elongate light sources in the form of tubular lamps extending in the longitudinal direction of the tunnel. These light sources have the drawback, however, that no or hardly any lighting control takes place in the longitudinal direction of the tunnel, so that the above state advantages are not therefore achieved.

The distance can be reduced still further, i.e., to distances less than 0.5 m, by applying light source with light outputs, which are more than a factor often smaller than those of usual gas-discharge lamps. This has the result that the variations in the light intensity discerned by drivers are greatly decreased.

The distance between the light sources is more preferably less than 0.05 m. Not only is the variation in light intensity hereby reduced still further, a guiding effect is moreover obtained. This is because drivers subconsciously tend to follow the illuminated band, which they can thus see, this enhancing road safety.

It is recommended that the light sources are each provided with at least one LED. This is because LEDs have a long lifespan, which a greater part of the generated light can be used efficiently than is the case in gas-discharge lamps, since LEDs do not emit omnidirectional light. It is also expected that the efficiency of LEDs manufactured in the near further will increase.

According to a preferred embodiment, the light sources are adapted to generate a light beam, the main direction of which comprises a main component extending opposite to the traffic direction. The visible contrast for drivers of vehicles traveling in the tunnel is hereby greatly increased relative to the contrast of usual, symmetrical prior art lighting devices for the interior of the tunnel, wherein the main direction of the light exiting the light sources extends parallel to the transverse plane of the tunnel. A surface of a possible obstacle in the tunnel facing the driver is after all hardly illuminated, so that it contrasts sharply with the tunnel walls and the road surface that are illuminated. As a result of the fact that semi-diffuse scattering surfaces reflect the light more in the direction away from the light source than toward the light source, the lighting level of the tunnel walls and the road surface visible to the driver is also greater. As a result of the two above stated effects, the lighting level in the tunnel can be reduced, this resulting in lower energy costs.

Such a light distribution can be obtained when the LEDs are placed with a component of their main beam direction opposite to the traffic direction. Only few demands need then be made of the optical means for converting the light generated by the LED to the exiting light, such as reflectors and lenses.

It is, however, also possible for the light sources to be provided with an optical element with an axial direction which extends with a component opposite to the traffic direction.

For some situations, it can be attractive for the light sources to be adapted to generate a light beam, the main direction of which comprises a component extending in the traffic direction, this representing the most useful solution for such a lighting device.

For such situations, the LEDs can be place with a component of their main beam direction in the traffic direction, although it is also possible for the light sources to be provided with an optical element with an axial direction which extends with a component in the traffic direction.

It is equally possible to apply a symmetrical light distribution. All these light distributions can be achieved by appropriate placing of LEDs of the relevant optical means, such as lenses or reflectors or a combination thereof. In a symmetrical light distribution, it is otherwise possible to adapt the light sources to alternately generate a main light beam with a directional component opposite to the direction of traffic and in the direction of traffic. The direction of traffic in tunnel tubes can change a result of the closure of parallel tunnel tubes or when the tunnel tube is used alternately in both directions. A symmetrical distribution can of course be used in such situations, although it is also possible for the light sources to be adapted to change the main direction of the light beam.

It is noted here that the light sources are received in fittings, preferably fittings extending in the longitudinal direction of the tunnel tube. A plurality of light sources will generally be arranged in such a fitting. In order to obtain a continuous band, it is recommended that the fittings are placed connecting to each other. Although it is not recommended, it is possible to envisage the fittings being placed at a mutual distance, for instance with an intermediate space equal to half the length of a fitting or the length of a fitting. This achieves only some of the advantages of the invention. It is also possible to envisage some of the fittings being switched off at night, for instance alternatively, whereby a similar effect is achieved. It is, however, more attractive to achieve a lower light level by dimming the light sources. Although in most cases the light sources are placed arrange in a single line against the ceiling of the tunnel tube, it is not precluded for the light sources to be arranged in more than a single line against the tunnel tube ceiling.

Yet another preferred embodiment provides the measure that the light sources are placed in fittings, and that fittings which are placed closer than a predetermined distance to the entrance of the tunnel tube are provided with a light source adapted to generate a light level which gradually changes from that in the vicinity of the tunnel entrance to that in the interior of the tunnel. This embodiment is suitable for use in tunnels in the vicinity of the tunnel entrances. There is, after all, a sudden transition here of light levels from that of daylight to that of the tunnel lighting. In order to allow this transition to take place gradually, the light level is reduced in each fitting as the distance from the tunnel entrance increases. This per se known measure can be combined with the measures according to the invention. The invention is further elucidated in the accompanying drawings.

### BRIEF DESCRIPTION OF THE DRAWINGS

FIG. 1 is a schematic longitudinal sectional view of a tunnel tube which is provided with a tunnel lighting device according to a first embodiment of the invention;

FIG. 2 shows a view corresponding with FIG. 1 of a tunnel tube provided with a second embodiment;

FIG. 3 shows a view corresponding with FIG. 1 of a tunnel tube provided with a third embodiment;

FIG. 4 is a cross-sectional detail view of the first embodiment;

FIG. 5 is a cross-sectional detail view of the second embodiment; and

FIG. 6 is a cross-sectional detail view of the third embodiment;

### DETAILED DESCRIPTION OF THE INVENTION

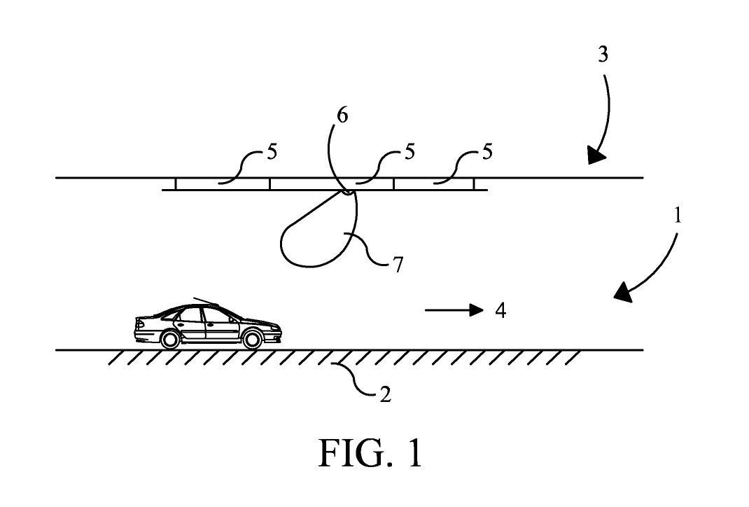

FIG. 1 shows a tunnel tube 1, which is enclosed by a roadway 2 and a ceiling 3.

Tunnel tube 1 is of course provided with sidewalls, which are not shown in the drawing. The sidewalls usually transpose into ceiling 3 by means of a curved part. The tunnel tube is adapted to guide the traffic in a traffic direction indicated by an arrow 4.

A number of light fittings 5 are fixed against the ceiling. In the present case, these are fittings placed parallel to the axis of the tunnel tube 1, although it will also be apparent that the fittings can be place in other configurations. Fittings 5 also connect to each other, although it is likewise possible for fittings 5 to be placed at regular intermediate distances.

Light sources 6 provided with LEDs are preferably placed in fittings 5. Other, approximately point-like light sources 6 can be placed instead of light sources 6 provdied with LEDs. Each of the light sources 6 is adapted to emit light with a distribution comprising a predominant component in the direction opposite to the traffic direction in tunnel tube 1. This is represented in FIG. 1 by a polar diagram 7. It will be apparent that in order to achieve the effects as indicated above, the major part of the light emitted by the light source has a directional component opposite to the traffic direction.

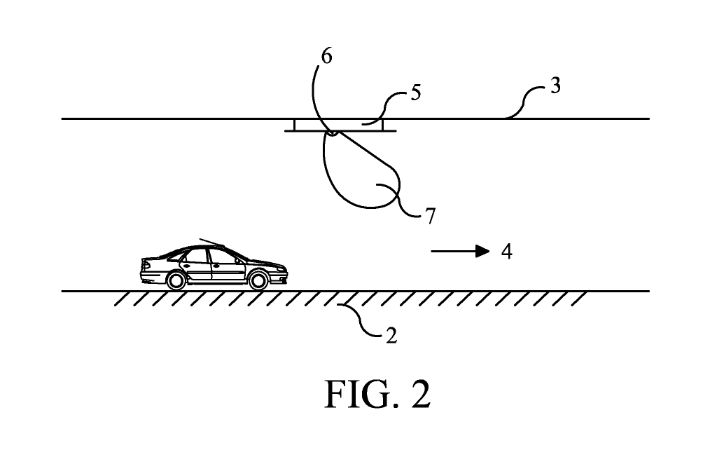

FIG. 2 shows an embodiment which corresponds to the embodiment shown in FIG. 1, but wherein the main direction of the light emitted by light sources 5 corresponds to the direction of traffic in tunnel 1, as shown by polar diagram 7. It will otherwise be apparent that the light has a component in the vertical direction, since it must, after all, shine downward from ceiling 3 of tunnel 1, as in the embodiment shown in FIG. 1.

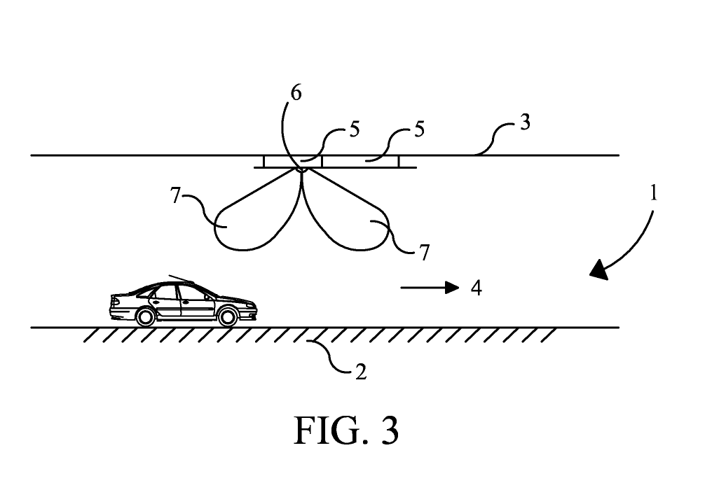

FIG. 3 shows an embodiment, which largely corresponds with the foregoing embodiments but where the light exiting light sources 6 is divided into two main beams, wherein the main direction of each of the beams is provided with respective components in the direction of traffic in tunnel tube and opposite to this direction. It is recommended that the light distribution is symmetrical, although it cannot be precluded that one of the main beams, preferably the main beam with a component opposite to the traffic direction, is more powerful than the other beam. The light intensity directly downward from the light source will, however, be lower than that of the main beams, so that the polar diagram comprises two lobes, as shown in FIG. 3.

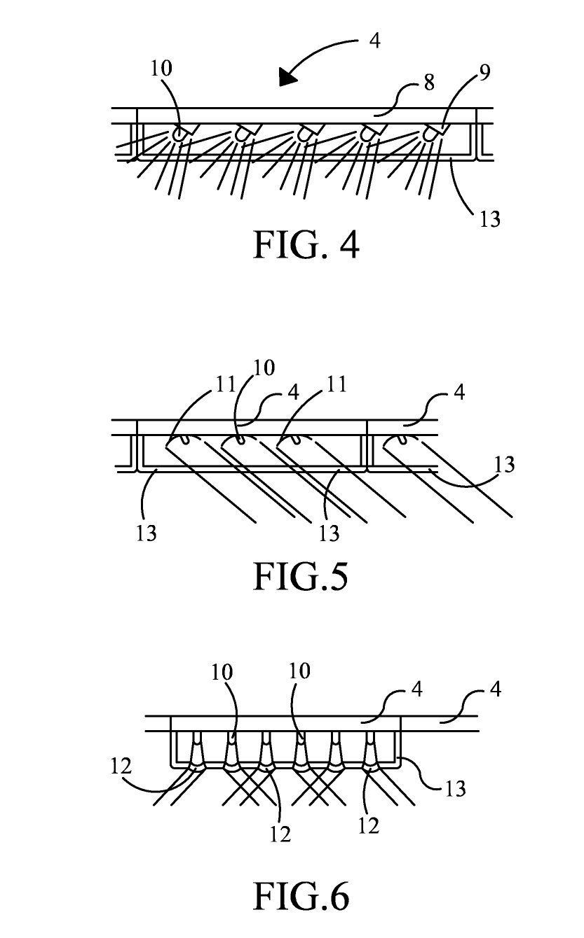

FIG. 4 shows in more detail a fitting 4 as shown in FIG. 1. Fitting 4 comprises a housing 8, which is provided with means for fixing the fitting to the tunnel tube ceiling. Fitting 4 is further provided with a number of LED carriers 9, in the present case five, which are adapted to mount LEDs 10 at an angle relative to the vertical. LEDs 10 are hereby mounted with their axis in the direction with a component opposite to the traffic direction and with a component in a vertical direction.

The desired light distribution is obtained when, as is usually the case, the main beam of a LED corresponds with its axis. The fitting is closed on its underside by a cover 13 manufactured from transparent material.

It will be apparent to the skilled person that ballasts for LEDs will be present in the housing, and preferably also means for interconnecting the successively connected fittings.

In the above elucidated embodiment, the desired light distribution is obtained by appropriate placing of the LEDs, although the effect can likewise be obtained by other means, such as by applying a reflector, a lens or a combination thereof.

FIG. 5 shows in more detail a fitting 4 as shown in FIG. 2. In this embodiment, fitting 5 is adapted to emit a light beam with a main direction, which has a component the same as that of the traffic direction 4 in the tunnel tube 1. In contrast to the embodiment shown in FIG. 4, use is made for this purpose of reflectors, which are adapted to emit such a directed light beam. It will be apparent that, instead of the reflector 11 shown here, use could also be made of obliquely placed LED carriers 9 as shown in FIG. 4, possibly in combination with reflectors or lenses. Use is also made in this embodiment of three LEDs 10; other numbers of LEDs could also be used.

Finally, FIG. 6 shows a detail of the embodiment shown in FIG. 3, wherein use is made of lenses 12 for the purpose of forming the obliquely directed light beams. As in the foregoing embodiment, LEDs 10 are here placed directly in housing 8. As in the foregoing embodiments, a cover 13 provided with lenses 12 is place on the underside of housing 8. Cover 13 can be transparent between lenses 12, for instance when lenses 12 are integrated into cover 13, although it is also possible for cover 13 to be manufactured from a non-transparent material and for lenses 13 to be inset therein. A particular feature in this embodiment is the fact that LEDs 10 alternating generates light in a main direction with a horizontal component in opposite directions. Light beams are hereby generated with the configuration shown in FIG. 3. It is, however, also possible to generate such light beams by splitting the light beam generated by each LED into two parts, making use of appropriate reflectors or lenses. The shown embodiment further provides the option of switching the LEDs on alternating, for instance, in tunnel tubes with a changeable traffic direction.

It will be apparent that the measures shown in the above discussed embodiments can be combined with each other.

What is claimed is:

1. A lighting device for lighting a tunnel tube with a traffic direction, comprising a number of individual approximately point-like light sources which are fixed against a tunnel tube wall, distributed along a line extending in the longitudinal direction of the tunnel and each adapted to generate a light beam, the main direction of which comprises at least one component extending in the traffic direction of the tunnel, characterized in that the distance between the light sources in the longitudinal direction of the tunnel is less than 5 m.

2. The lighting device as claimed in claim 1, wherein the distance between the light sources is less than 0.5 m.

3. The lighting device as claimed in claim 2, wherein the distance between the light sources is less than 0.2 m.

4. The lighting device as claimed in claim 1, wherein the light sources are each provided with at least one LED, each of said light sources being adapted to generate a light beam, the main direction of which comprises a main component extending opposite to the traffic direction.

5. The lighting device as claimed in claim 2, wherein the light sources are each provided with at least one LED, each of said light sources being adapted to generate a light beam, the main direction of which comprises a main component extending opposite to the traffic direction.

6. The lighting device as claimed in claim 3, wherein the light sources are each provided with at least one LED, each of said light sources being adapted to generate a light beam, the main direction of which comprises a main component extending opposite to the traffic direction.

7. The lighting device as claimed in claim 1, wherein the light sources are each provided with at least one LED placed with a component of their main beam direction opposite to the traffic direction.

8. The lighting device as claimed in claim 2, wherein the light sources are each provided with at least one LED placed with a component of their main beam direction opposite to the traffic direction.

9. The lighting device as claimed in claim 3, wherein the light sources are each provided with at least one LED placed with a component of their main beam direction opposite to the traffic direction.

10. The lighting device as claimed in claim 1, wherein the light sources are provided with at least one LED and said light sources being provided with an optical element with an axial direction which extends with a component opposite to the traffic direction.

11. The lighting device as claimed in claim 2, wherein the light sources are each provided with at least one LED and said light sources being provided with an optical element with an axial direction which extends with a component opposite to the traffic direction.

12. The lighting device as claimed in claim 3, wherein the light sources are each provide with at least one LED and said light sources are provided with an optical element with an axial direction which extends with a component opposite to the traffic direction.

13. The lighting device as claimed in claim 1, wherein the light sources are each adapted to generate a light beam, the main direction of which comprises a component extending in the traffic direction.

14. The lighting device as claimed in claim 2, wherein the light sources are each provided with at least one LED and said light sources are each adapted to generate a light beam, the main direction of which comprises a component extending in the traffic direction.

15. The lighting device as claimed in claim 3, wherein the light sources are each provided with at least one LED and said light sources are each adapted to generate a light beam, the main direction of which comprises a component extending in the traffic direction.

16. The lighting device as claimed in claim 13, wherein said at least one LED is placed with a component of their main beam direction in the traffic direction.

17. The lighting device as claimed in claim 1, wherein the light sources are each provided with at least one LED and said light sources are provided with an optical element with an axial direction which extends with a component in the traffic direction.

18. The lighting device as claimed in claim 2, wherein the light sources are each provided with at least one LED and said light sources are provided with an optical element with an axial direction which extends with a component in the traffic direction.

19. The lighting device as claimed in claim 3, wherein the light sources are each provided with at least one LED and said light sources are provided with an optical element with an axial direction which extends with a component in the traffic direction.

20. The lighting device as claimed in claim 1, wherein the light sources are adapted to emit a light beam which is substantially symmetrical in the traffic direction.

21. The lighting device as claimed in claim 2, wherein the light sources are adapted to emit a light beam which is substantially symmetrical in the traffic direction.

22. The lighting device as claimed in claim 3, wherein the light sources are adapted to emit a light beam which is substantially symmetrical in the traffic direction.

23. The lighting device as claimed in claim 4, wherein the light sources are adapted to emit a light beam which is substantially symmetrical in the traffic direction.

24. The lighting device as claimed in claim 5, wherein the light sources are adapted to emit a light beam which is substantially symmetrical in the traffic direction.

25. The lighting device as claimed in claim 1, wherein the light sources are provided with an optical element which results in a symmetrical light distribution in the traffic direction.

26. The lighting device as claimed in claim 2, wherein the light sources are provided with an optical element which results in a symmetrical light distribution in the traffic direction.

27. The lighting device as claimed in claim 3, wherein the light sources are provided with an optical element which results in a symmetrical light distribution in the traffic direction.

28. The lighting device as claimed in claim 4, wherein the light sources are provided with an optical element which results in a symmetrical light distribution in the traffic direction.

29. The lighting device as claimed in claim 1, wherein the light sources are adapted to change the main direction of the light beam.

30. The lighting device as claimed in claim 4, wherein the lighting device comprises fittings which extend in the longitudinal direction of the tunnel and which are each provided with more than one light source.

31. The lighting device as claimed in claim 4, wherein the light sources are placed in fittings, the fittings which are placed closer than a predetermined distance to the entrance of said tunnel tube being provided with a light source adapted to generate a light level which gradually changes from that in the vicinity of the tunnel entrance to that in the interior of the tunnel.

32. A lighting device for lighting a tunnel tube with a traffic direction, comprising a number of individual approximately point-like light sources which are fixed against a tunnel tube wall, distributed along a line extending in the longitudinal direction of the tunnel and each of said light sources adapted to alternately generate a main light beam with a directional component opposite to the direction of the traffic and with a directional component in the direction of traffic which results in a symmetrical light distribution in the traffic direction.

33. A fitting for receiving a light source as claimed in claim 4.
